(19) United States
(12) Patent Application Publication
(10) Pub. No.: US 2002/0194104 A1
(43) Pub. Date: Dec. 19, 2002

(54) Raw material exchange system

(76) Inventors: William S. Reamer, Ithaca, NY (US); Neil Wallace, Ithaca, NY (US); Damian Eonta, Sewickley, PA (US); Charles Quttilla, Ingomar, PA (US)

Correspondence Address: BROWN & MICHAELS, PC, 400 M & T BANK BUILDING, 118 NORTH TIOGA ST, ITHACA, NY, 14850, US

(21) Appl. No.: 09/860,009

(22) Filed: May 17, 2001

(51) Int. Cl. G06F 17/60

(52) U.S. Cl. 705/37; 705/26

(57) ABSTRACT

A method for providing to purchasers of goods, including used goods, availability to an on-line market at which the purchasers' needs can be fulfilled from one or multiple sources in the context of a reverse-auction, includes the steps of one or more buyers posting to an on-line market one or more desired exchange items, one or more sellers posting to the on-line market one or more offers to sell one or more exchange items, a buyer accepting, in whole or part, at least one of the sellers' offers, the buyer entering how much of each of the sellers' offer(s) it accepts, and an on-line marketplace provider notifying via e-mail at least one seller of a buyer's acceptance of the seller's offer.

### BACKGROUND OF THE INVENTION

1. Field of the Invention

The invention pertains to the field of providing an on-line reverse-auction marketplace for goods. More particularly, the invention pertains to a method for providing to purchasers of such goods, including used goods, availability to an on-line market at which the purchaser's needs can be fulfilled from one or multiple sources in the context of a reverse-auction.

2. Description of Related Art

“Freemarket” (http://www.freemarkets.com) is a reverse-auction web site based on a one bid per person model, where there is one supplier selling at one price, and a potential buyer must take all of the commodity offered. There is no per-buyer authorization procedure; once a buyer or seller has the Freemarket software, it can sell to any buyer or buy from any seller. Freemarket has to approve a person to get the software; a seller has to be notified of an auction manually, and can then dial in and bid. A real-time on-line auction, on the other hand, is more like a chat line, wherein all users are logged on during the auction (e.g., “Commerce1”, http://www.commerce1.com).

### SUMMARY OF THE INVENTION

Briefly stated, a method for providing to purchasers of goods, including used goods, availability to an on-line market at which the purchaser's needs can be fulfilled from one or multiple sources in the context of a reverse-auction, includes the steps of one or more buyers posting to an on-line market one or more desired exchange items, one or more sellers posting to the on-line market one or more offers to sell one or more exchange items, a buyer accepting, in whole or part, at least one of the sellers' offers, the buyer entering how much of the sellers' offer(s) it accepts, and an on-line marketplace provider notifying via e-mail at least one seller of a buyer's acceptance of the seller's offer.

### BRIEF DESCRIPTION OF THE DRAWING

FIG. 1 shows the Category Lists Screen of an embodiment of the invention.

FIG. 2 shows the Specific Chosen Category Screen of an embodiment of the invention.

FIG. 3 shows the Search Results Screen of an embodiment of the invention.

FIG. 4 shows the Item Bidding Screen of an embodiment of the invention (in three parts).

FIG. 5 shows the Auction Closing Screen of an embodiment of the invention (in two parts).

FIG. 6 shows the New User Registration Screen of an embodiment of the invention.

FIG. 7 shows the Change Categories Screen of an embodiment of the invention.

FIG. 8 shows the Specific Chosen Category Screen of an embodiment of the invention.

### DETAILED DESCRIPTION OF THE INVENTION

The system of the present invention is practiced using well-known communication tools, such as a networked computer and web browser, e-mail, fax and telephone. No special software or training is required and sellers deal directly with buyers, thus potentially reducing or eliminating broker's fees and thereby reducing costs to buyers and effectively expanding sellers' markets.

The method of the invention is relatively simple and very easy to use. It starts when a potential buyer of goods or raw materials, such as, for example, scrap metals, uses a computer to log on to a network, in order to communicate with an on-line marketplace provider offering an on-line market. The buyer then posts his requirements to the system; other buyers may do the same. Included in such a posting is a product description and shipping instructions, as well as terms and conditions designated by the buyer. For example, a buyer may post a requirement for 10,000 tons of tool steel. A potential seller of goods or raw materials uses a computer to log on to the network, in order to communicate with the on-line marketplace provider, and once logged into the system, the seller may examine the exchange board and peruse the list of buyers and their needs.

In order to submit an offer on a given product that a buyer has indicated it needs, a seller must be approved by a third party certifier (e.g., the on-line marketplace provider) to sell that particular product or commodity to the particular buyer conducting the exchange. Once such an approval to sell the product to an individual buyer is given, the seller can submit an offer on all or part of that particular buyer's requirements.

The invention is characterized in that buyers and sellers deal directly with one another. The buyer is able to view every supply offer made, the identity of the seller (or company) making the offer, the price offered, and the proposed quantity offered. The buyer may then select any offer or offers that are acceptable, and after such selections are made, e-mail notifications are automatically sent by the on-line service provider to each successful seller chosen by the buyer. Such offers constitute an agreement between the buyer and the chosen seller. A purchase order is then sent to the seller. Sellers may change their offers at any time prior to the closing bell. When the exchange closes, each seller has made a legal offer to sell. Once a bid is accepted, the seller is notified via e-mail.

In regard to sellers (or suppliers), any seller must be pre-approved to furnish offers to buyer A, and separately pre-approved to furnish offers to buyer B (and similarly for any other buyers). Once approved for those buyers, sellers also must be authorized individually to make offers on each specific commodity, such that the on-line marketplace provider can determine whether a particular seller is able to provide the volume and quality required by a specific buyer of a specific item. The on-line marketplace provider keeps track of these data, which enable it to allow or disallow sellers from making offers to buyers for whom a particular seller is or is not approved, and further to prevent a particular seller from making offers to buyers for whom a particular seller is approved, but not authorized for a particular product or commodity.

In regard to buyers, the buyers are preferably allowed to see only their own screens; that is, they can only see the items that they have posted. However, all sellers that respond to a particular buyer's requests for purchase can be viewed by that buyer, although sellers' responses to other buyers cannot be seen by them (i.e., the other buyers). Thus, buyers cannot see other buyers and their posted items, whereas sellers, on the other hand, can see all requests for items that have been posted by all buyers.

To begin the buying process, a user logs in to the system and must qualify as a buyer. A buyer then posts an exchange item (e.g., I need M tons of X), and sellers T, U, V, W (i.e., suppliers) offer to sell X at price Y. A buyer optionally accepts Z% of X at price Y from a seller W, Q% of X at price YY from a seller U, etc. A buyer enters how much of each offer it accepts, and the on-line marketplace provider then sends e-mail to sellers (optionally with comments), notifying a seller of a buyer's acceptance of the seller's offer. Sellers can make multiple offers, for example, X tons at $Y, M tons at $N, etc., however, sellers must be authorized to supply each specific commodity to each specific buyer. A seller is authorized to furnish an offer of each particular commodity to each individual buyer, based on information supplied to the marketplace provider and subsequently to the buyer. That is, each individual item must be authorized for each buyer to make an offer to each seller.

Sellers can see every auction, but cannot bid until authorized to do so; an indication that a seller wishes to bid initiates the approval process. The marketplace provider pre-approves a seller to furnish offers to buyers individually (i.e., separate approval to furnish offer to buyers A and B, etc.), as well as individually for each specific commodity (i.e., pre-approval of commodity, volume and quality), based on personal knowledge, such as, for example, through visual inspection of the product or commodity offered. A seller must be specifically authorized to make offers to each given buyer, but sellers are not subjected to repeat inspections. Although a seller may offer a specific quantity, a buyer can accept any quantity. The marketplace provider keeps track of pre-authorization data to allow or disallow suppliers from making offers to buyers for which they are not approved, or keeps them from making offers to buyers for which they are approved, but for which they are not authorized for a particular commodity. Buyers must sign an agreement with the marketplace provider to use the on-line market system, and the marketplace provider makes a commission on posted exchanges by buyers.

### EXAMPLE 1—InternetScrap.com

The present example creates a “Buyer's Exchange” in the context of a reverse-auction, by employing logic based on a combination of a lowest bid basis and a buyer's discretion basis. An example of program logic based on buyer's discretion is a logic whereby a buyer has the option when the exchange closes to pick and choose sellers at the buyer's discretion, and not based solely on the lowest offer.

Buyers Log in to Their Own Screen:

Buyers log in to an on-line marketplace provider's site to post items that they would like to purchase, and thereby solicit offers from sellers. Preferably, buyers are allowed to see only their own screens. That is, buyers are not allowed to see other buyers' information, rather, buyers are able to view only their own posted items. However, all sellers that respond to a particular buyer's requests for purchase can be viewed by that buyer, although sellers' responses to other buyers cannot be seen by them (i.e., the other buyers). Thus, buyers cannot see other buyers and their items, whereas sellers, on the other hand, can see all requests for items that have been posted by all buyers. Thus, search results display only current buyers' items, and a particular buyer's display page only displays the items posted by that buyer.

A buyer must confirm on each submission that it is the authorized buyer and that it has legitimately logged in, such as, for example, by entering a password and buyer identification code into a hidden value that is submitted each time the user submits a form while logged in. The password preferably is encrypted, so that it cannot be read visually (i.e., in the browser address bar), preferably using an encryption method that can translate both ways (i.e., from English to encryption and from encryption to English). For example, a Per1 script will create a code once a password is entered and confirmed, and then translate the code back each time a form is submitted and compared with the password on file. Without this feature, it would be relatively easy for a hacker, or even a user, to log in as someone else and then submit the other user's name without a password, thereby allowing users to obtain access to buyers' data.

A given buyer who logs in preferably specifies a given location for the company. For example—John Doe has a profile of location: Birmingham, Company: US Steel, while John Smith has a profile of location: Pittsburgh, Company: US Steel.

Disallowing Buyers from Seeing other Buyers' Items:

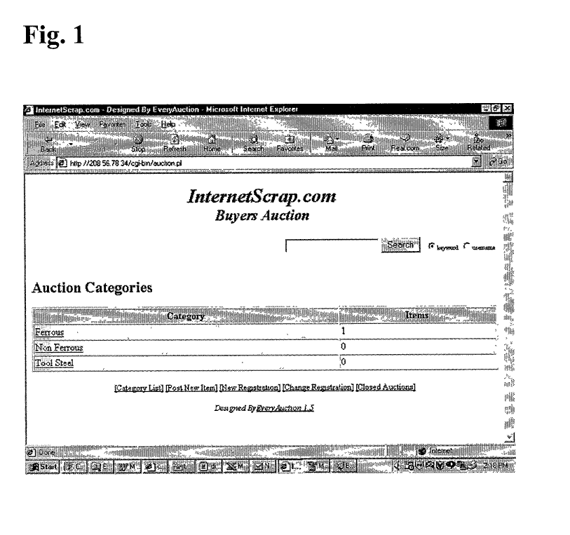

Disallowing buyers to see other buyers' posted items is accomplished by changing the logic in four main screens. For example, referring now to FIGS. 1-4, in each of the four screens shown in the figures, the buyer is only allowed to view his own items:

The Category Lists Screen (see FIG. 1)

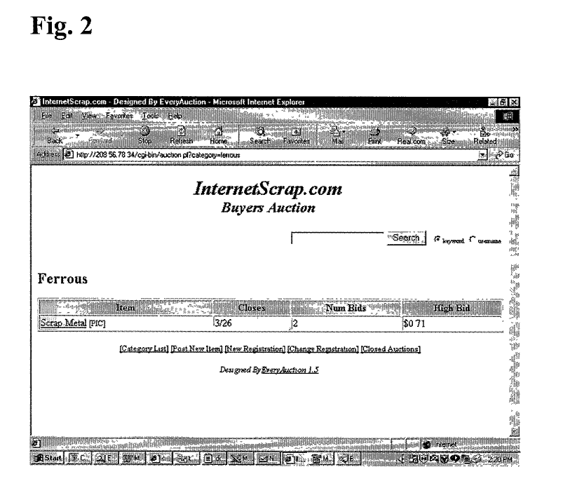

The Specific Chosen Category Screen (see FIG. 2)

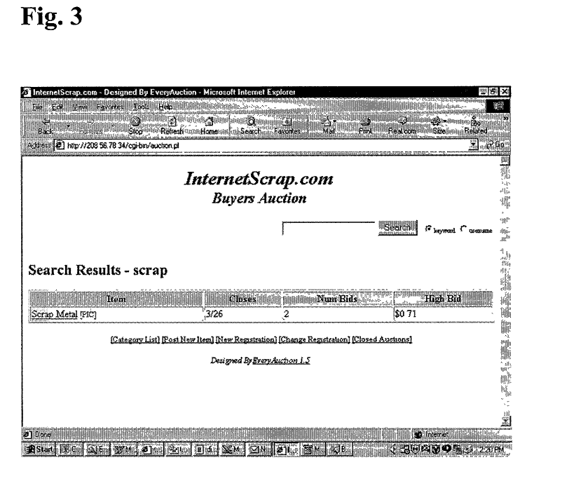

The Search Results Screen (see FIG. 3)

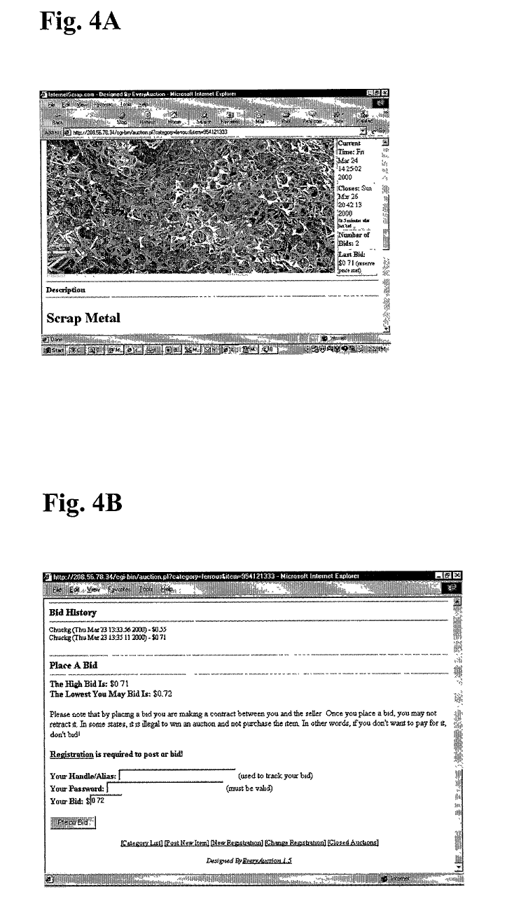

The Item Bidding Screen (see FIGS. 4A-4B)

If a buyer wants to do a search for a seller by seller's name, this can be allowed, but the search results will only display that particular buyer's items (i.e., the buyer's items for which the seller has made an offer).

Disallowing Buyers from Bidding on Anything:

By changing the above-mentioned screens and only allowing buyers to post an item that they want to purchase, the invention effectively disallows buyers to bid on anything, as the normal logic does. They will not be able to get to the bidding screen of someone else's item.

Auction Closing—Disallowing Viewing of Others' Postings:

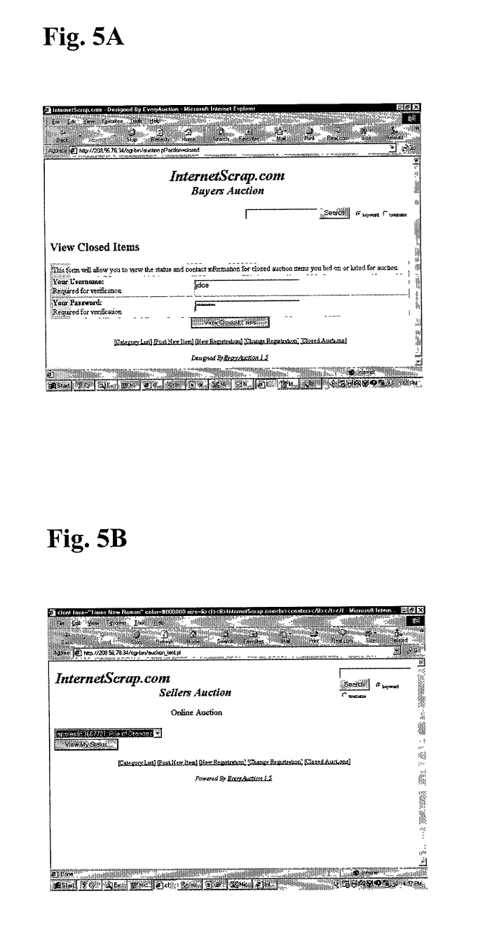

Referring now to FIGS. 5A-5B, at auction closing, the buyer preferably enters his buyer identification code and password. This brings him to the next screen, which displays all items the buyer has posted for sellers to make offers on. The system allows the user to see only items that the buyer has either bid on or posted for sale. As explained above, the buyer cannot bid on any items, so the buyer cannot see any other items than its own from this auction closing screen.

Creating Buyer's Login and Sellers Login Screens:

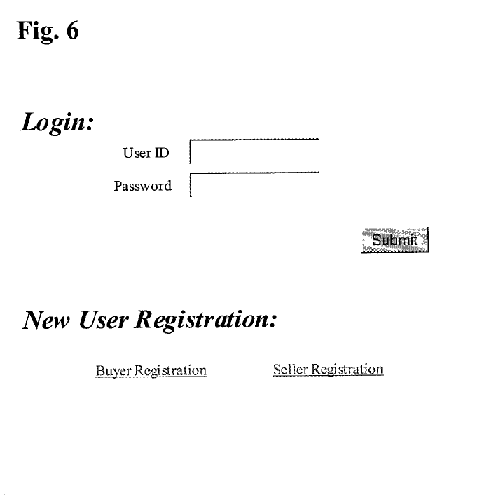

Referring now to FIG. 6, the main content of the log in screens appears as shown in the figure. Preferably, the standard header and footer also appear (not shown).

The system verifies that the buyer or seller identification code is on file and that the password is correct. In addition, all screens verify that the password and buyer or seller identification code are still correct by using the encryption convention described above. If the user is not yet registered, then the user is provided access to a buyer and seller registration link.

Buyer and Seller Registration:

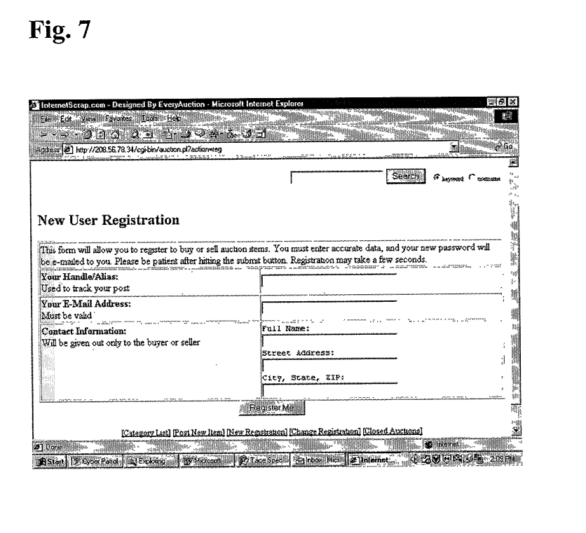

A potential buyer or seller creates a new user registration page by entering the specified information into the New User Registration Screen, which is shown generally in FIG. 7. If the new user is a potential buyer, then the title is “Buyers Registration.” Although the example shown in FIG. 7 shows the term “Your Handle/Alias,” other appropriate terms are optionally used, such as, for example, “User ID” or “Buyer ID.” Similarly, if the new user is a potential buyer, then the words “or sell” would not appear on the screen, and the phrase “Will be given out only to the buyer or seller” would be changed to “Will be given out only to the seller” and, optionally, there would be additional buyer-specific fields, such as, for example, “Company Name,” “Location” and “URL for Company Logo.” Once the information has been entered, the system checks to make sure the user is not already registered as either a buyer or seller. Similarly, if the new user is a potential seller, then the title would be “Sellers Registration” and optionally there would be additional seller-specific fields.

Seller Authorization by Buyer:

The Item/Bidding Screen preferably is split into two separate screens, initially showing only the item information on the first page, and also displaying a “bidding area” button and another button for requesting authorization from the buyer. When a seller clicks this button, it brings up a message that states, “Send registration information to this buyer. If authorized, the buyer will contact your bidding password.” The seller clicks OK to request authorization, and another page is displayed that states that the seller's request is being e-mailed to the buyer. The password sent to the buyer is then written to a new file—the buyer password file. The password is needed to gain entrance to the buyer's area by a seller.

When a seller clicks the bidding area button, the system checks to see if the seller's identification code is in the bidders authorization file. If it is not, the system prompts the user for the password that the buyer needs to supply him with. The user may then enter the password and click proceed. The password is checked against the buyer password file, and if it is correct, then the seller obtains access and his name is added to the authorized sellers for this buyer. This negates the need to enter the password each time. The system then notifies the seller that this password is no longer needed. Once the seller gains access to the bidding area, the bid history is displayed, although the other sellers' names are withheld, and the user identification code and password are removed from or hidden from view on the bidding page.

Bid History Configurable:

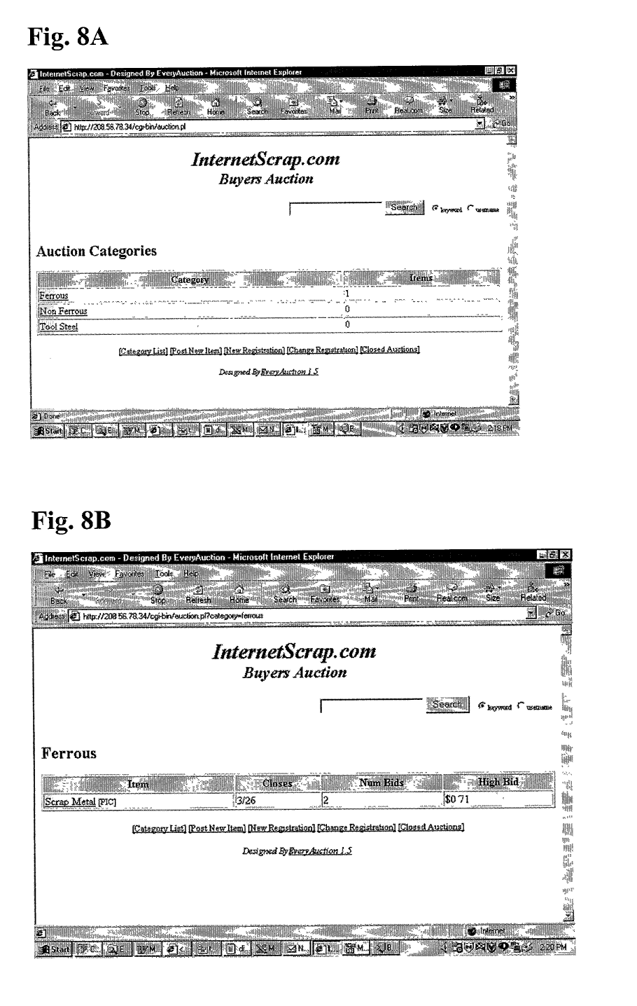

The invention allows for a configuration screen to set the number of bids that are viewed by sellers. The invention also allows a user to log in as “admin” at the first screen. As shown generally in FIGS. 8A-8B, the Categories Screen (FIG. 8A) is configured to display only the number of items posted by the current buyer, and the Specific Chosen Category Screen for the current buyer is configured to display only the records for that buyer.

Searching:

The invention does not allow a buyer to view items posted by other buyers, or to view information posted by other buyers or companies. Search results are sorted as follows:

Company Name

Location (example—Birmingham)

Item 1

Item 2

Location (example—Pittsburgh)

Item 3

Item 4

The Search Results appear generally as shown in the table below, and are displayed on the screen shown in FIG. 8B (i.e., the data below would replace those shown in FIG. 8B).

US Steel

| | | | Num | High | |
|---|---|---|---|---|---|
| Location | Item | Closes | Bids | Bid | UOM |
| Birmingham | Scrap Metal | 3/27 | 3 | $0.711 | 1b |
| Birmingham | Sheet Steel | 3/25 | 1 | $0.560 | 1b |
| Pittsburgh | Aluminum | 3/24 | 20 | $0.459 | 1b |
| Pittsburgh | Scrap Metal | 3/29 | 10 | $0.503 | 1b |

Exchange Closing Logic:

The invention allows a buyer to choose more than one seller, if desired. Thus, a buyer can choose as many sellers as desired, and whatever quantities from each seller that it desires (up to the total quantity offered by the seller).

Immediately upon closing of the exchange, the system sends e-mail to winning sellers, indicating the quantity and price specified, and sends e-mail to the buyer with seller names, e-mail addresses, quantity and price for each seller and total quantity and price.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method for providing an on-line market system for buyers and sellers of goods, through which said buyers' needs are fulfilled by one or more sellers in the context of a reverse-auction, comprising the steps of:
a) one or more buyers posting to said on-line market one or more desired exchange items;
b) one or more sellers posting to said on-line market one or more offers to sell one or more of said exchange items;
c) a buyer accepting, in whole or part, at least one of said sellers' offers;
d) said buyer entering how much of each of said sellers' offer it accepts;
e) an on-line marketplace provider notifying via e-mail at least one seller of a buyer's acceptance of said seller's offer.

2. The method of claim 1 wherein said sellers are pre-approved separately to furnish offers to each of said one or more buyers.

3. The method of claim 2 wherein said sellers, once pre-approved separately to furnish offers to each of said one or more buyers, are authorized individually to furnish separate offers for specific commodities.

4. The method of claim 1 wherein said sellers make a plurality of offers to said buyers.

5. The method of claim 1 wherein said marketplace provider makes a commission on posted exchanges by buyers.

6. The method of claim 1 wherein sellers must be authorized to supply a specific commodity to a specific buyer.

7. The method of claim 1 further comprising the step of a buyer signing an agreement with said marketplace provider to use said on-line market system.

8. The method of claim 1 wherein a seller is authorized by a buyer, based on information supplied by said marketplace provider.

9. The method of claim 1 wherein each specific exchange item must be authorized.

10. The method of claim 1 wherein sellers can see a buyer's postings, but cannot furnish an offer until so authorized by said marketplace provider

11. The method of claim 1 wherein a buyer's indication that it wishes to post an exchange item initiates an approval process with said marketplace provider.

12. The method of claim 1 wherein said marketplace provider pre-approves one or more sellers to furnish offers to one or more buyers individually, as well as individually for each specific commodity, based on said marketplace provider's personal knowledge.

13. The method of claim 1 wherein said marketplace provider keeps track of pre-authorization data to allow or disallow sellers to make authorized offers to buyers.
